(19) United States
(12) Patent Application Publication
(10) Pub. No.: US 2010/0019535 A1
(43) Pub. Date: Jan. 28, 2010

(54) Fuel Door Interlock for Vehicle Sliding Door

(75) Inventors: Houng Yue Chang, Canton, MI (US); David A. Barney, Waterford, MI (US); Ching-Hui Chiang, Ann Arbor, MI (US); Richard Tomasello, Ann Arbor, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/179,950

(22) Filed: Jul. 25, 2008

(51) Int. Cl. B60J 5/06

(52) U.S. Cl. 296/155

(57) ABSTRACT

An interlock system for a vehicle body with a sliding door and a fuel fill door includes a housing, a first member, a second member, and a spring. The first member is mounted with respect to the housing, defines a cam portion, and is selectively rotatable with respect to the housing in a first direction from a retracted position to an extended position. The second member is mounted with respect to the housing and is selectively rotatable with respect to the housing in the first direction between a first position and a second position. The spring interconnects the first and second members such that movement of the second member from the first position to the second position causes the first member to move from the retracted position to the extended position.

### TECHNICAL FIELD

This invention relates to interlock systems that are configured to obstruct movement of a vehicle sliding door to its open position when a fuel filler door is open.

### BACKGROUND OF THE INVENTION

Van type vehicles often include a sliding door mounted on tracks by which the door slides rearwardly to permit access to the vehicle passenger compartment. A fuel filler door on the side wall of a vehicle typically conceals a fuel filler cap. In some vehicles, the fuel filler door is inaccessible when the sliding door is open, i.e., the opened sliding door obstructs access to the fuel filler door. Accordingly, an inadvertent attempted opening of the sliding door when the fuel filler door has already been opened will cause the sliding door to interfere with the fuel filler door.

### SUMMARY OF THE INVENTION

An interlock system is provided for a vehicle body with a sliding door and a fuel fill door having respective closed and open positions. The interlock system includes a housing, a first member, a second member, and a spring. The first member is mounted with respect to the housing, defines a cam portion, and is selectively rotatable with respect to the housing in a first direction from a retracted position to an extended position. The second member is mounted with respect to the housing and is selectively rotatable with respect to the housing in the first direction between a first position and a second position. The spring interconnects the first and second members such that movement of the second member from the first position to the second position causes the first member to move from the retracted position to the extended position. The housing is mountable to the vehicle body such that, when the first member is in the extended position, the cam portion prevents the sliding door from moving from its closed position to its open position.

The second member is operatively connectable to the fuel filler door such that movement of the fuel filler door to its open position causes the second member to move to its second position, which in turn causes the first member to move such that the cam portion prevents the sliding door from opening.

The spring that interconnects the first and second members transmits force and motion between the first and second members during ordinary operation. However, the spring permits relative movement of the first and second members in certain situations. For example, if the connection between the second member and the fuel fill door is such that opening the fuel fill door rotates the second member more than is necessary to block the sliding door, the second member can rotate independently of the first member once the first member is in its extended, blocking position. Similarly, if the sliding door is not in the closed position when the fuel fill door is open, the first member can rotate independently of the second member to allow the sliding door to close. Furthermore, if there is some damage to the sliding door or the surrounding area, the fuel fill door may still be operational, because, even if the first member is locked and cannot rotate, the second member, when connected to the fuel fill door, can still rotate independently.

A corresponding vehicle is also provided. The vehicle includes a vehicle body having a sliding door and a fuel fill door, which are selectively movable between respective open and closed positions. An interlock system includes a housing mounted with respect to the vehicle body, a first member rotatably mounted with respect to the housing, a second member rotatably mounted with respect to the housing, and a spring. The first member defines a cam portion and is selectively rotatable with respect to the housing in a first direction from a retracted position to an extended position. When the first member is in the retracted position, the cam portion does not interfere with movement of the sliding door from its closed position to its open position. When the first member is in the extended position, the cam portion prevents the sliding door from moving from its closed position to its open position.

The second member is selectively rotatable with respect to the housing in the first direction between a first position and a second position. The spring sufficiently interconnects the first and second members such that movement of the second member from the first position to the second position causes the first member to move from the retracted position to the extended position.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a vehicle including a sliding passenger door, a fuel fill door, and an interlock system having a cam assembly;

FIG. 2 is a schematic, perspective view of the cam assembly with a cam lever in a retracted position;

FIG. 3 is a schematic, perspective view of the cam assembly with the cam lever in an extended position;

FIG. 4 is a schematic, perspective view of the cam assembly with the cam lever in the retracted position;

FIG. 5 is a schematic, perspective view of the cam assembly with the cam lever in the extended position;

FIG. 6 is a schematic, perspective view of the cam lever and a trigger lever;

FIG. 7 is a schematic, sectional view of the door and the cam assembly with the cam lever in the retracted position;

FIG. 8 is a schematic, sectional view of the door and the cam assembly with the cam lever in the extended position; and

FIG. 9 is a schematic, section view of the door and the cam illustrating movement of the door from a partially open position toward the closed position

### DESCRIPTION OF THE PREFERRED EMBODIMENTS

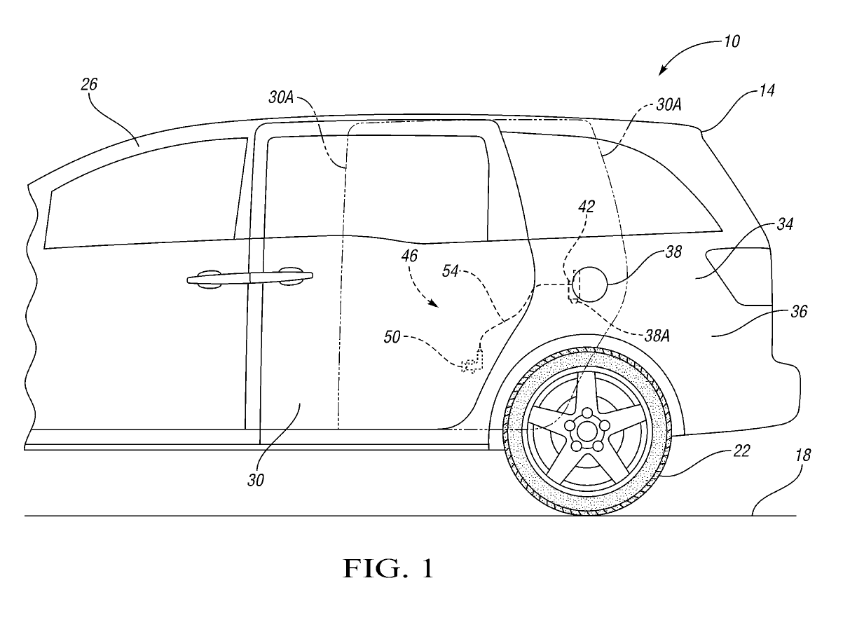

Referring to FIG. 1, a vehicle 10 includes a vehicle body 14 supported above the ground 18 by a plurality of wheels 22, as understood by those skilled in the art. The vehicle body 14 includes a front door 26, which is selectively pivotable between open and closed positions, and a sliding rear door 30. The sliding rear door 30 is movably mounted with respect to a rear quarter panel 34, such as via a track (not shown) as understood by those skilled in the art. The sliding rear door 30 is movable along the track from a closed position, as shown at 30 to an open position, as shown at 30A. In the open position, the door 30A is rearward and outboard of its closed position.

The quarter panel 34 defines a sidewall 36 of the vehicle body 14. The sidewall 36 is generally vertically oriented, and is characterized by a fuel fill opening through which fuel may be added to the vehicle's fuel tank (not shown), as understood by those skilled in the art. The vehicle body 14 also includes a fuel filler door 38. The fuel filler door 38 is rotatably mounted to the quarter panel 34 via a hinge 42, and is selectively rotatable about the hinge 42 between a closed position, as shown at 38, and an open position, as shown in phantom at 38A. When the fuel filler door 38 is in the closed position, the fuel filler door 38 obstructs the fuel fill opening in the quarter panel 34. When the fuel filler door 38 is rotated to its open position, the fuel filler door 38 does not obstruct the fuel fill opening. When in its open position, the fuel filler door 38 is generally orthogonal to the sidewall 36, and thus protrudes into the travel path of the door 30. Accordingly, the fuel filler door 38 and the sliding door 30 cannot be in their respective open positions at the same time.

The vehicle also includes an interlock assembly 46 configured to prevent the sliding door 30 from moving to its open position when the fuel filler door 38 is in the open position. The interlock assembly 46 includes a cam assembly 50 and a flexible cable 54. The cable 54 is operatively connected to the fuel filler door 38 such that movement of the fuel filler door 38 to its open position pulls the cable 54 away from the cam assembly 50.

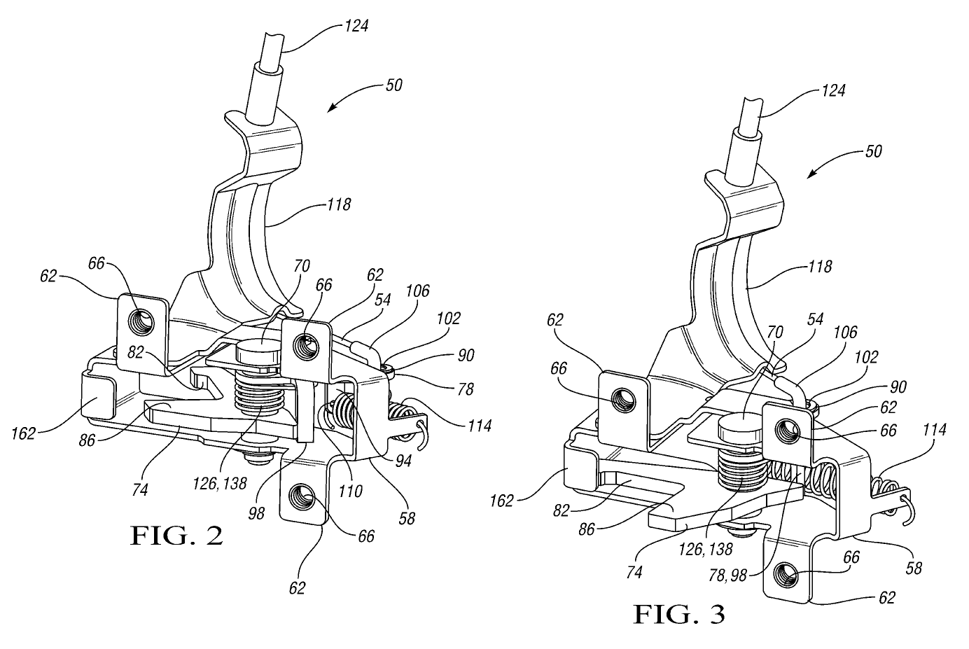

Referring to FIGS. 2-6, the cam assembly 50 includes a housing 58. The housing 58 includes mounting tabs 62 for mounting the housing 58 to the vehicle body 14. Each tab 62 defines a respective hole 66 for receiving a fastener (not shown), such as a bolt, to fasten the housing 58 to the body 14. The housing 58 supports a pin 70. A cam lever 74 and a trigger lever 78 are selectively rotatable about the pin 70.

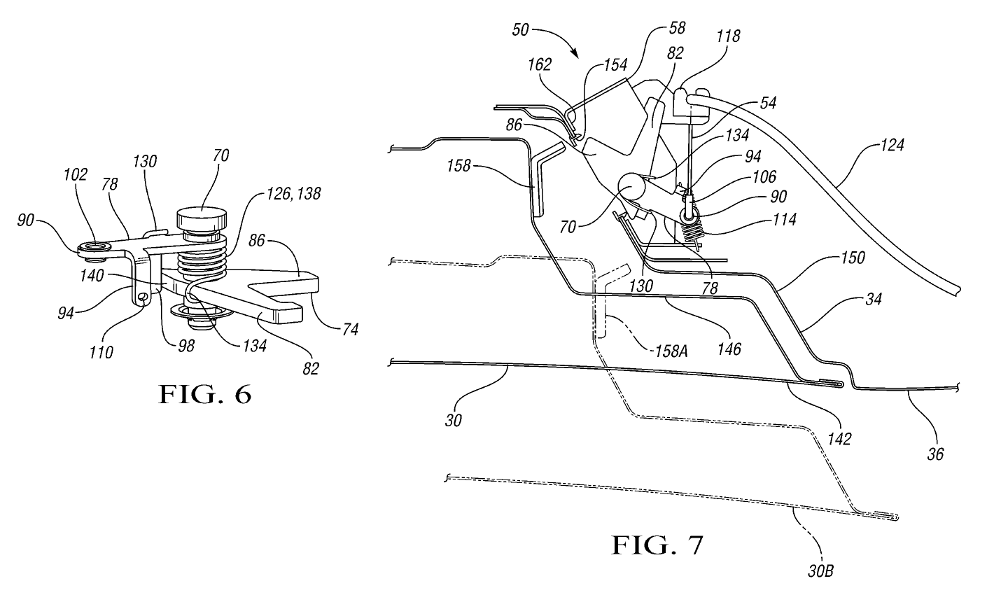

The cam lever 74 includes a stop arm 82 and a cam portion 86. As best seen in FIG. 6, the trigger lever 78 includes a first arm 90, a second arm 94, and a third arm 98. The first arm 90 defines a hole 102. A hook 106 is engaged with the trigger lever 78 at the hole 102. The hook 106 is connected to the cable 50. The second arm 94 includes a hole 110. One end of a spring 114 engages the trigger lever 78 at hole 110, and the other end of the spring 114 is attached to the housing 58. Arm 98 is angled to selectively contact cam lever 74.

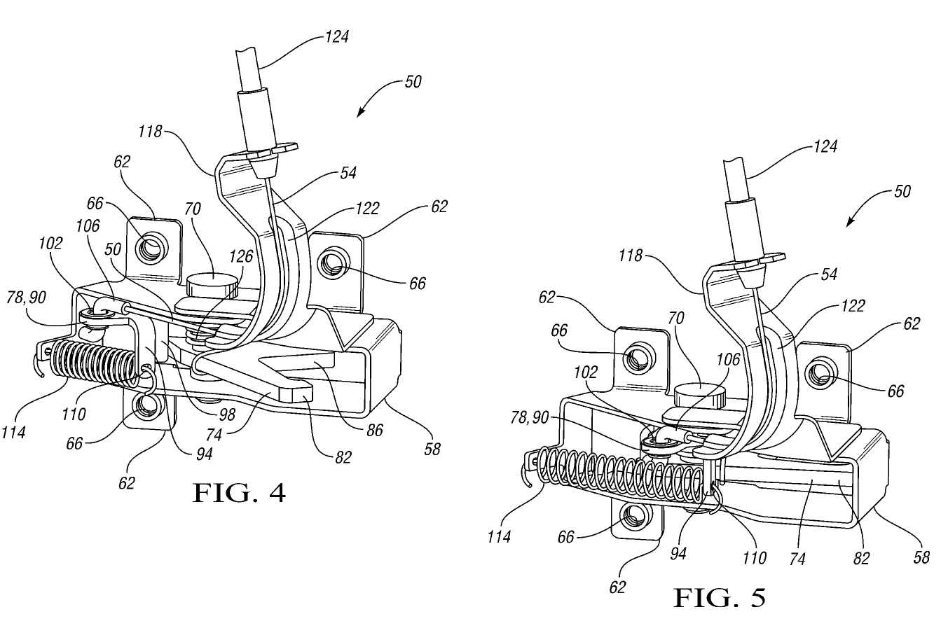

The cam lever 74 is selectively rotatable about the pin 70 between a retracted position, as shown in FIGS. 2 and 4, and an extended position, as shown in FIGS. 3 and 5. The trigger lever 78 is selectively rotatable about the pin 70 between an untriggered position, as shown in FIGS. 2 and 4, and a triggered position, as shown in FIGS. 3 and 5. The spring 114 biases the trigger lever 78 in the untriggered position. The cam assembly 50 also includes a gooseneck-shaped cable carrier 118, which is mounted to the housing 58. The cable carrier 118 defines a channel 122 that contains a portion of the cable 54. The channel 122 is configured to guide the cable 54 such that a tensile force on the cable 54 is transmitted to the trigger lever 78, via hook 106, in a manner that results in the movement of the trigger lever 78 to its triggered position. The cable 54 is operatively connected to the fuel filler door (shown at 38 in FIG. 1), such that opening the fuel filler door causes a tensile force on the cable 54, and thus causes movement of the trigger lever 78 to its triggered position. As the trigger lever 78 is moved into its triggered position, the spring 114 is subjected to a tensile strain, as seen in FIGS. 3 and 5. A protective sheath 124 surrounds a portion of the cable 54 to provide a Bowden cable configuration. The spring 114 is preloaded so that the preload tension pulls the cable 54 tightly to prevent rattling.

The cam assembly 50 also includes a torsion spring 126 having a hook portion 130 at one end and another hook portion 134 at the other end. The torsion spring 126 is characterized by a central coil portion 138 between the two hook portions 130, 134. The central coil portion 138 concentrically surrounds the pin 70. As best seen in FIG. 6, hook 130 connects the spring 126 to arm 98 of the trigger lever 78. Hook 134 connects the spring 126 to the cam lever 74. The torsion spring 126 is preloaded to urge the arm 98 of the trigger lever 78 against a surface 140 of the cam lever. Thus, the interaction of the arm 98 against the cam lever 74 limits the rotation of the trigger lever 78 with respect to the cam lever 74, and maintains the stress on the spring 126. The spring 126 transmits force between the trigger lever 78 and the cam lever 74 such that the trigger lever 78 and the cam lever 74 move together as a single unit during typical operation. Accordingly, movement of the trigger lever 78 from the untriggered position to the triggered position causes movement of the cam lever 74 from its retracted position to its extended position.

Referring to FIG. 7, wherein like reference numbers refer to like components from FIGS. 1-6, the door 30 includes an outer panel 142 and an inner panel 146 operatively connected to one another, such as by hemming. The quarter panel 34 includes a portion 150 that extends inboard from the sidewall 36. Portion 150 defines what is sometimes referred to as a “dog leg.” The portion 150 of the quarter panel 34 defines a hole 154. The cam assembly 50 is mounted to the portion 150 such that the cam portion 86 of the cam lever 74 is selectively extendable through the hole 154.

An angled bracket 158 is mounted to the inner panel 146 of the door 30. The door is shown in its closed position at 30. The initial movement of the door 30 from its closed position to its open position includes linear translation from the closed position to an intermediate position shown in phantom at 30B. Accordingly, the bracket 158 is characterized by linear translation from the position shown at 158, when the door 30 is closed, to the position shown in phantom at 158A when the door 30 is in the intermediate position.

In FIG. 7, the fuel filler door (shown at 38 in FIG. 1) is in its closed position, and thus the trigger lever 78 is in the untriggered position and the cam lever 74 is in its retracted position. In the retracted position, the cam portion 86 does not cross the path of the bracket 158 in its travel between the position shown at 158 and the position shown at 158A. Accordingly, the door 30 is unobstructed in its movement from its closed position toward its open position.

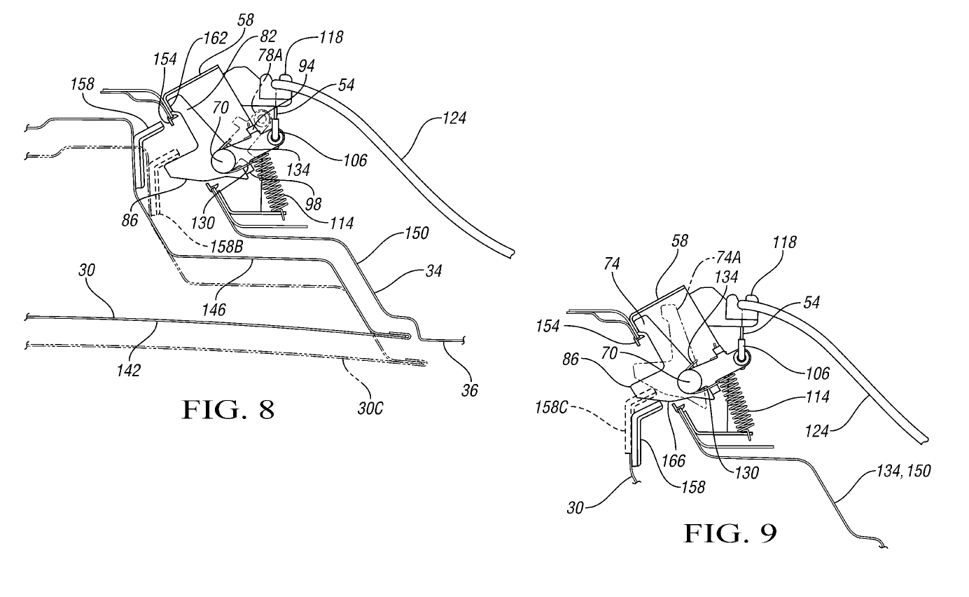

When the fuel filler door is moved to its open position, it produces a tensile force on the cable 54, which causes the trigger lever 78 to rotate in a first direction to its triggered position; the spring 126 transmits force and motion from the trigger lever 78 to the cam lever 74, which in turn causes the cam lever 74 to rotate in the first direction to its extended position, as shown in FIG. 8. Referring to FIG. 8, the cam portion 86 of the cam lever 74 extends into the path of the bracket 158, and thus limits movement of the door 30 from its closed position to an intermediate position shown in phantom at 30C. More specifically, when the bracket, as shown in phantom at 158B, contacts the cam portion 86, movement of the door 30 past the position shown at 30C requires the cam lever 74 to further rotate in the first direction about the pin 70. However, the stop arm 82 contacts a tab stop 162 formed in the housing 58, which prevents any further rotation of the cam lever 74 in the first direction.

It should be noted that the trigger lever 78 is movable in the first direction with respect to the cam lever 74 once the stop arm 82 has contacted the tab stop 162 by straining the torsion spring 126, thereby accommodating dimensional variance in the length of the cable 54, etc. More specifically, the trigger lever 78 is movable in the first direction from its triggered position, as shown in phantom at 78A, by straining spring 126.

Referring to FIG. 9, when the fuel fill door is open, the cam portion 86 of the cam lever 74 blocks the path of the bracket 158. However, the cam assembly 50 is configured to permit movement of the door 30 from an open position to the closed position when the cam portion 86 blocks the path of the bracket 158. As the door 30 is moved toward the closed position, the bracket 158 contacts a surface 166 of the cam portion 86, urging the cam lever 74 to rotate in a second direction opposite the first direction. Although the trigger lever 78 is maintained in its triggered position by the cable 54, the bracket 158 causes the cam lever 74 to move relative to the trigger lever 78 in the second direction by straining the torsion spring 126. Thus, as the door 30 moves toward its closed position, the bracket moves to the position shown at 158C, which causes the cam lever to rotate to the position shown in phantom at 74A, out of the path of the bracket 158, thereby permitting the closure of the door 30.

Referring again to FIG. 8, when the fuel fill door is closed, tension on the cable 54 is removed, and the spring 114 forces the trigger lever 78 to rotate in the second direction to the untriggered position. In turn, the arm 98 of the trigger lever 78 acts on the cam lever 74, and forces the cam lever 74 to rotate in the second direction to its retracted position.

While the best modes for carrying out the invention have been described in detail, those familiar with the art to which this invention relates will recognize various alternative designs and embodiments for practicing the invention within the scope of the appended claims.

1. An interlock system for a vehicle body with a sliding door and a fuel fill door having respective closed and open positions, the interlock system comprising:
a housing;
a first member mounted with respect to the housing, defining a cam portion, and being selectively rotatable with respect to the housing in a first direction from a retracted position to an extended position;
a second member mounted with respect to the housing and being selectively rotatable with respect to the housing in the first direction between a first position and a second position; and
a spring interconnecting the first and second members such that movement of the second member from the first position to the second position causes the first member to move from the retracted position to the extended position;
wherein the housing is mountable to the vehicle body such that, when the first member is in the extended position, the cam portion prevents the sliding door from moving from its closed position to its open position.

2. The interlock system of claim 1, wherein the interlock system includes a member sufficiently positioned to prevent the first member from rotating in the first direction when the first member is in its extended position

3. The interlock system of claim 2, wherein the second member is rotatable in the first direction from the second position by straining the spring.

4. The interlock system of claim 3, wherein the spring biases a portion of the second member against the first member.

5. The interlock system of claim 4, wherein the spring biases the portion of the second member against the first member in a second direction opposite the first direction.

6. The interlock system of claim 3, wherein the first member is rotatable with respect to the second member in a second direction opposite the first direction when the first member is in the extended position.

7. The interlock system of claim 1, further comprising a flexible member operatively connected to the second member and operatively connectable to the fuel fill door such that movement of the fuel fill door from its closed to its open position causes movement of the second member from its first position to its second position.

8. A vehicle comprising:
a vehicle body including a sliding door and a fuel fill door being selectively movable between respective open and closed positions;
an interlock system including a housing mounted with respect to the vehicle body, a first member rotatably mounted with respect to the housing, a second member rotatably mounted with respect to the housing, and a spring;
said first member defining a cam portion and being selectively rotatable with respect to the housing in a first direction from a retracted position, in which the cam portion does not interfere with movement of the sliding door from its closed position to its open position, to an extended position in which the cam portion prevents the sliding door from moving from its closed position to its open position;
said second member being selectively rotatable with respect to the housing between a first position and a second position; and
said spring sufficiently interconnecting the first and second members such that movement of the second member from the first position to the second position causes the first member to move from the retracted position to the extended position.

9. The vehicle of claim 8, wherein the interlock system includes a member sufficiently positioned to prevent the first member from rotating in the first direction when the first member is in its extended position.

10. The vehicle of claim 9, wherein the second member is rotatable in the first direction from the second position by straining the spring.

11. The vehicle of claim 10, wherein the spring biases a portion of the second member against the first member.

12. The vehicle of claim 11, wherein the spring biases the portion of the second member against the first member in a second direction opposite the first direction.

13. The vehicle of claim 10, wherein the first member is rotatable with respect to the second member in a second direction opposite the first direction when the first member is in the extended position.

14. The vehicle of claim 8, further comprising a flexible member operatively interconnecting the fuel filler door and the second member such that movement of the fuel filler door from its closed to its open position causes movement of the second member from its first position to its second position.
